(19) United States
(12) Patent Application Publication
(10) Pub. No.: US 2025/0018707 A1
(43) Pub. Date: Jan. 16, 2025

(54) FOIL TRANSFERRING APPARATUS, TRANSFERRING APPARATUS, FOIL TRANSFERRING METHOD, AND TRANSFERRING METHOD

(71) Applicant: BROTHER KOGYO KABUSHIKI KAISHA, Nagoya (JP)

(72) Inventors: Shuji KAWASAKI, Nagoya (JP); Hideaki YAMADA, Nagoya (JP); Isami FUJISAWA, Gifu (JP); Tomoya ICHIKAWA, Nagoya (JP)

(73) Assignee: BROTHER KOGYO KABUSHIKI KAISHA, Nagoya (JP)

(21) Appl. No.: 18/899,617

(22) Filed: Sep. 27, 2024

Related U.S. Application Data
(63) Continuation of application No. PCT/JP2023/009284, filed on Mar. 10, 2023.

(30) Foreign Application Priority Data
Mar. 29, 2022 (JP) 2022-053303

(51) Int. Cl. B41F 16/00

(52) U.S. Cl. CPC B41F 16/006; B41F 16/0026

(57) ABSTRACT

There is provided a foil transferring apparatus, including: a housing having a receiver to receive a film cartridge, and an opening, the film cartridge being configured to be attached to and detached from the receiver through the opening, the film cartridge including a supplying reel to which a foil film having foil is wound; a winding reel, and a memory storing information indicating a type of the foil film; a transferring part configured to transfer the foil to a sheet by heating the foil film and the sheet in a state that the foil film and the sheet are overlapped with each other; and a controller configured to change an amount of heat to be applied per unit area of the foil film from the transferring part based on the information indicating the type of the foil film obtained from the memory.

### REFERENCE TO RELATED APPLICATIONS

This application is a continuation of International Patent Application No. PCT/JP 2023/009284 filed on Mar. 10, 2023, that claims priority from Japanese Patent Application No. 2022-053303 filed on Mar. 29, 2022. The entire content of those applications is incorporated herein by reference.

### BACKGROUND ART

Conventionally, as a foil transferring apparatus, an apparatus including a film cartridge having a memory is known. In this technique, a foil transfer is performed under the optimum conditions according to a specification of the film cartridge, by reading data such as the specification of the film cartridge etc. from the memory.

### SUMMARY

However, the foil transferring apparatus described above does not take into account which information in the memory is used, which condition of the foil transfer is changed, and how a condition is changed.

In view of the above, a purpose of the present disclosure is to provide a foil transferring apparatus, a foil transferring method, a transferring apparatus, and a transferring method each of which can perform transfer appropriately by using information in a memory of a film cartridge.

According to a first aspect of the present disclosure, there is provided a foil transferring apparatus including:
a housing having a receiver configured to receive a film cartridge, and an opening, the film cartridge being configured to be attached to and detached from the receiver through the opening, the film cartridge including:
a supplying reel to which a foil film having foil is wound;
a winding reel configured to wind the foil film; and
a memory storing information indicating a type of the foil film;
a transferring part configured to transfer the foil to a sheet by heating the foil film and the sheet in a state that the film cartridge is attached to the receiver and that the foil film supplied from the supplying reel and the sheet are overlapped with each other; and
a controller configured to change an amount of heat to be applied per unit area of the foil film from the transferring part based on the information indicating the type of the foil film obtained from the memory.

According to the above configuration, the controller changes the amount of the heat to be applied per unit area of the foil film from the transferor based on the information indicating the type of the foil film obtained from the memory. Thus, the controller can perform the transferring of the foil appropriately by using information in the memory of the film cartridge.

According to a second aspect of the present disclosure, there is provided a foil transferring method executable by a foil transferring apparatus, the foil transferring apparatus including:
a housing having a receiver configured to receive a film cartridge, and an opening, the film cartridge being configured to be attached to and detached from the receiver through the opening, the film cartridge including:
   a supplying reel to which a foil film having foil is wound;
   a winding reel configured to wind the foil film; and
   a memory storing information indicating a type of the foil film;
a transferring part configured to transfer the foil to a sheet; and
a controller,
the foil transferring method including:
heating the foil film and the sheet by the transferring part in a state that the film cartridge is attached to the receiver and that the foil film supplied from the supplying reel and the sheet are overlapped with each other;
obtaining the information indicating the type of the foil film from the memory, by the controller, and
changing, by the controller, an amount of heat to be applied per unit area of the foil film from the transferring part based on the information indicating the type of the foil film obtained from the memory.

According to a third aspect of the present disclosure, there is provided a transferring apparatus including:
a housing having a receiver configured to receive a film cartridge, and an opening, the film cartridge being configured to be attached to and detached from the receiver through the opening, the film cartridge including:
   a supplying reel to which a film is wound, the film including a transferring layer and a support layer supporting the transferring layer;
   a winding reel configured to wind the film; and
   a memory storing information indicating a type of the film;
a transferring part configured to transfer the transferring layer to a sheet by heating the film and the sheet in a state that the film cartridge is attached to the receiver and that the film supplied from the supplying reel and the sheet are overlapped with each other; and
a controller configured to change an amount of heat to be applied per unit area of the film from the transferring part based on the information indicating the type of the film obtained from the memory.

According to a fourth aspect of the present disclosure, there is provided a transferring method executable by a transferring apparatus, the transferring apparatus including:
a housing having a receiver configured to receive a film cartridge, and an opening, the film cartridge being configured to be attached to and detached from the receiver through the opening, the film cartridge including:
   a supplying reel to which a film is wound, the film including a transferring layer and a supporting layer supporting the transferring layer;
   a winding reel configured to wind the film; and
   a memory storing information indicating a type of the film;
a transferring part configured to transfer the transferring layer to a sheet; and
a controller,
the transferring method including:

heating the film and the sheet by the transferring part in a state that the film cartridge is attached to the receiver and that the film supplied from the supplying reel and the sheet are overlapped with each other;
obtaining the information indicating the type of the film from the memory, by the controller, and
changing, by the controller, an amount of heat to be applied per unit area of the film from the transferring part based on the information indicating the type of the film obtained from the memory.

According to the present disclosure, transferring can be performed appropriately by using information in a memory of a film cartridge.

### BRIEF DESCRIPTION OF DRAWINGS

FIG. 1A depicts a foil transferring apparatus. FIG. 1B is a cross-sectional view depicting a configuration of a foil film.

FIG. 2 depicts a state in which a film cartridge is taken out from the foil transferring apparatus.

FIG. 3A is a perspective view depicting a first film unit. FIG. 3B is a perspective view depicting a second film unit. FIG. 3C is a perspective view depicting a third film unit.

FIG. 4 is a view depicting a heating roller, a first heater, and a second heater.

FIG. 5 is a view depicting a table stored in a controller.

FIG. 6 is a flowchart depicting an empty determining process in non-foil-transferring period.

FIGS. 7A and 7B are flowcharts depicting a foil transfer process.

### DESCRIPTION

An embodiment of the present disclosure will be described in detail with reference to the drawings as appropriate.

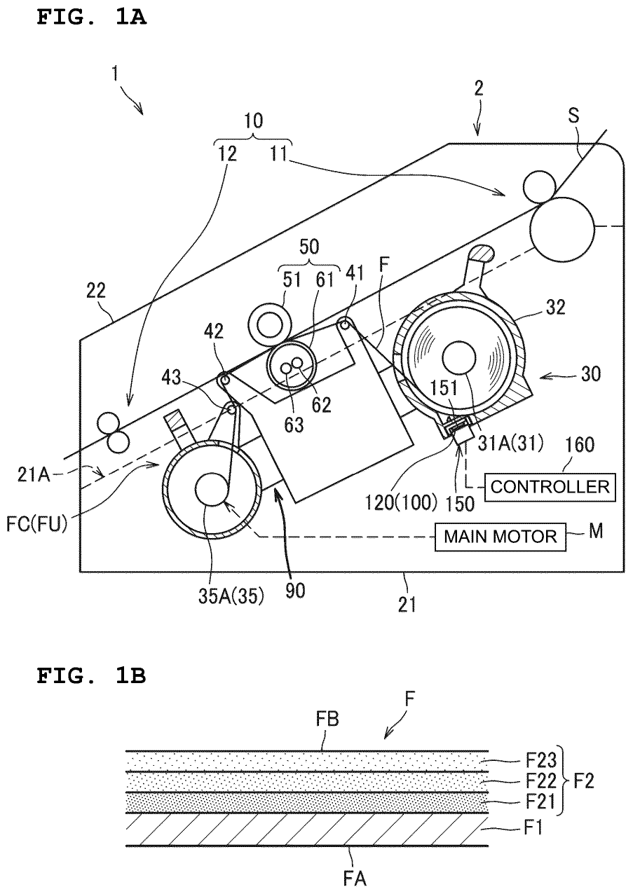

As depicted in FIG. 1A, a foil transferring apparatus 1 is an apparatus for transferring foil, such as gold foil etc., onto a toner image on a sheet S. Note that, the toner image is formed on the sheet S by an image forming apparatus such as, for example, a laser printer etc. The foil transferring apparatus 1 includes a housing 2, a sheet conveying part 10, a film supplying part 30, a transferring part (a transferor, or a transcriber) 50, and a controller 160.

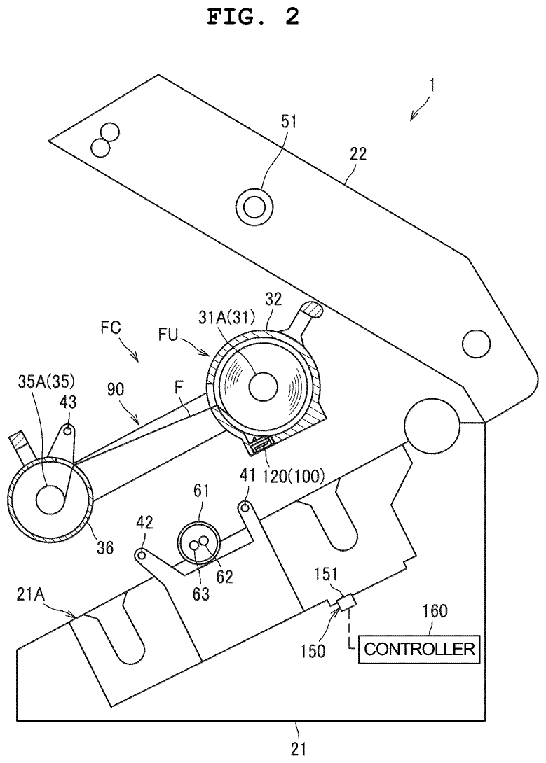

The housing 2 is made of resin etc., and includes a housing body 21 and a cover 22. The housing body 21 has an opening 21A (see also FIG. 2) at the upper part of the housing body 21. The cover 22 opens and closes the opening 21A. The cover 22 is pivotally supported by the housing body 21. The cover 22 is pivotable between a closing position (the position depicted in FIG. 1A) at which the cover 21 closes the opening 21A, and an opening position (the position depicted in FIG. 2) at which the cover 21 opens the opening 21A.

The sheet conveying part 10 includes a sheet supplying mechanism 11 and a sheet discharging mechanism 12. The sheet conveying part 10 is driven and rotated by a main motor M to be described later. The sheet supplying mechanism 11 is a mechanism configured to convey the sheets S on the sheet tray (not depicted) one by one toward the transferring part 50.

The sheet discharging mechanism 12 is a mechanism configured to discharge the sheet S having travelled through the transferring part 50 to the outside of the housing 2.

The film supplying part 30 is a part configured to supply the foil film F such that the foil film F is overlapped with the sheet S conveyed from the sheet supplying mechanism 11. The film supplying part 30 includes a film cartridge FC, a first guiding shaft 41, a second guiding shaft 42, and a main motor M. The first guiding shaft 41 and the second guiding shaft 42 are disposed in the housing body 21 (see FIG. 2).

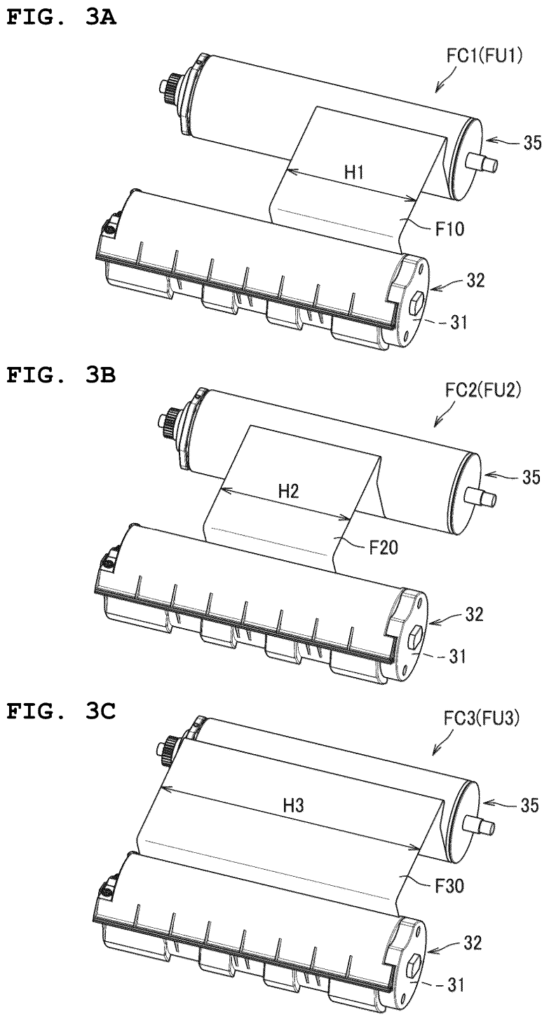

The film cartridge FC can be attached to and detached from the housing body 21 through the opening 21A, as depicted in FIG. 2. The film cartridge FC includes a film unit FU having the foil film F and a holder 90 configured to removably support the film unit FU. The holder 90 is configured such that one of the film units FU, such as depicted in FIGS. 3A to 3C, having colors of foils, widths of the foil films F, and positions in a width direction of the foil films F are different from each other, can be selectively attached to the holder 90.

As depicted in FIG. 1B, the foil film F is a film including a plurality of layers. Specifically, the foil film F includes a supporting layer F1 and a supported layer F2. The supporting layer F1 is a tape-like transparent base material made of polymeric material, and supports the supported layer F2. The supported layer F2 includes, for example, a peeling layer F21, a transferring layer F22, and an adhering layer F23. The peeling layer F21 is a layer configured to facilitate peeling of the transferring layer F22 from the supporting layer F1, and is disposed between the supporting layer F1 and the transferring layer F22. The peeling layer F21 contains a transparent material that is easily peeled off from the supporting layer F1, for example, a wax-based resin.

The transferring layer F22 is a layer configured to be transferred to the toner image, and contains foil. The foil means a thinly formed metal such as gold, silver, copper, aluminum, etc. The transferring layer F22 includes a coloring material such as gold, silver, red, etc., and a thermoplastic resin. The transferring layer F22 is disposed between the peeling layer F21 and the adhering layer F23.

The adhering layer F23 is a layer configured to facilitate adhering of the transferring layer F22 to the toner image. The adhering layer F23 contains a material that easily adheres to the toner image heated by the transferring part 50 to be described later, such as, for example, vinyl chloride resin or acrylic resin.

The film unit FU mainly includes a supplying reel 31, a supplying case 32, a winding reel 35, and a memory 100. The holder 90 includes a shaft 43.

The supplying reel 31 is made of resin etc., and includes a supplying shaft part 31A around which the foil film F is wound or to be wound. One end of the foil film F is fixed to the supplying shaft part 31A.

The supplying case 32 is a hollow case configured to house the supplying reel 31. The supplying case 32 is made of resin etc.

The winding reel 35 is made of resin etc., and has a winding shaft part 35A for winding the foil film F. The other end of the foil film F is fixed to the winding shaft part 35A. The winding shaft part 35A is driven and rotated by the main motor M.

The memory 100 is a medium configured to store information and is, for example, an IC chip. The memory 100 has an electric contact surface 120. The memory 100 is disposed in the supplying case 32.

The memory 100 stores specification information and usage history information on the foil film F. The specification information on the foil film F includes information indicating a type of the foil film F, information indicating a width and a position of the foil film F (that is, information indicating the width of the foil film F and information indicating the position of the foil film F), information indicating a length of a new foil film F, and the like. The memory 100 stores information indicating a color of the foil and manufacturer information indicating a manufacturer of the foil film F as the information indicating the type of the foil film F. The usage history information on the foil film F includes information indicating a length of the foil film F having been used, information indicating a remaining amount of the foil film F (i.e., a length of unused foil film F), information indicating a time period elapsed from a time point when the film cartridge FC was used for the first time, and the like. Note that, the length of the used foil film F may be calculated from a rotation amount of the supplying reel 31 or the winding reel 35. The memory 100 can be initialized by, for example, a personal computer owned by a maintenance supplier or the like.

The foil transferring apparatus 1 further includes a reader 150 configured to contact the memory 100 so as to read information from the memory 100.

The reader 150 is disposed in the housing body 21. The reader 150 is disposed at a position where the reader 150 faces the memory 100 in a case where the film cartridge FC is attached to the housing body 21. The reader 150 has an electric contact 151 configured to contact the electric contact surface 120 in a case where the film cartridge FC is positioned at an attachment position (i.e., a position at which the film cartridge FC is attached to the housing body 21). The electric contact 151 is disposed in the housing body 21. The reader 150 is connected to the controller 160.

The first guiding shaft 41 is a shaft configured to guide the foil film F. Specifically, the first guiding shaft 41 contacts the foil film F drawn out from the supplying reel 31 to change a travelling direction of the foil film F. The first guiding shaft 41 is made of SUS (stainless steel), for example.

The second guiding shaft 42 is a shaft configured to guide the foil film F. Specifically, the second guiding shaft 42 contacts the foil film F guided by the first guiding shaft 41 to change the travelling direction of the foil film F. The second guiding shaft 42 is made of SUS, for example.

The shaft 43 is a shaft for adjusting an angle of the foil film F when the foil film F (specifically, the supporting layer F1) is peeled from the sheet S. The shaft 43 is made of SUS etc. The shaft 43 contacts the foil film F guided by the second guiding shaft 42 to change the travelling direction of the foil film F.

The first guiding shaft 41 guides the foil film F drawn out from the supplying reel 31 so that the foil film F is overlapped with the sheet S which is being conveyed in a state that a surface on which the toner image is formed faces downward, from a position below the sheet S. The first guiding shaft 41 changes the conveying direction of the foil film F drawn out from the supplying reel 31 and guides the foil film F so that the foil film travels substantially in parallel with the conveying direction of the sheet S.

The second guiding shaft 42 is a peeling roller that contacts the foil film F travelled through the transferring part 50, and guides the foil film F in a direction separating from the sheet S by changing the conveying direction of the foil film F travelled through the transferring part 50 to a direction different from the conveying direction of the sheet S. The foil film F conveyed through the transferring part 50 in a state that the foil film F is overlapped with the sheet S is guided in a direction different from the travelling direction of the sheet S when the foil film F travels through the second guide shaft 42, and is peeled from the sheet S.

The transferring part 50 is a part for transferring the transferring layer F22 to the toner image formed on the sheet S by heating and pressurizing the sheet S and the foil film Fin a state that the sheet S and the foil film Fare overlapped with each other. The transferring part 50 includes a pressure roller 51, a heating roller 61, a first heater 62, and a second heater 63. The transferring part 50 overlaps the sheet S and the foil film F with each other and heats and pressurizes the sheet S and the foil film F in a state that the sheet S and the foil film Fare overlapped with each other, at the nip part between the pressure roller 51 and the heating roller 61.

The pressure roller 51 is a roller including a cylindrical core bar and a rubber layer, made of a silicone rubber, covering the cylindrical core bar. The pressure roller 51 is disposed above the foil film F and can contact a back surface of the sheet S (that is, a surface opposite to a surface on which the toner image is formed).

The pressure roller 51 is rotatably supported by the cover 22. The pressure roller 51 nips the sheet S and the foil film F with the heating roller 61 at a position between the pressure roller 51 and the heating roller 61. In a case where the pressure roller 51 is driven and rotated by the main motor M, the heating roller 61 is rotated following to the rotation of the pressure roller 51. In such a manner, the sheet S and the foil film Fare conveyed by the pressure roller 51 and heating roller 61 rotating in a state that the sheet S and the foil film F are nipped by the pressure roller 51 and the heating roller 61.

The heating roller 61 is formed to have a cylindrical shape. The first heater 62 and the second heaters 63 are disposed inside the heating roller 61 and heat the heating roller 61. The heating roller 61 is disposed below the foil film F and is in contact with the foil film F. The heating roller 61 can be pressed against or separated from the pressure roller 51 by a pressure-contact and detachment mechanism (not depicted).

The controller 160 includes a CPU, a ROM, a RAM, a nonvolatile memory, and the like, and is configured to perform various controls based on programs prepared in advance. The controller 160 has a function of pressing the heating roller 61 against the pressure roller 51 during a period in which the sheet S travels through the nip part of the transferring part 50, and of separating the heating roller 61 from the pressure roller 51 during a period in which the sheet S is not travelling through the nip part of the transferring part 50.

In the foil transferring apparatus 1 configured as above, the sheets S placed on a sheet tray (not depicted) is conveyed one by one toward the transferring part 50 by the sheet supplying mechanism 11. The sheet S is overlapped with the foil film F supplied from the supplying reel 31 at a position upstream in the sheet conveying direction of the transferring part 50, and is conveyed to the transferring part 50 in a state that the toner image on the sheet S and the foil film F are in contact with each other.

In the transferring part 50, when the sheet S and the foil film F travel through the nip part between the pressure roller 51 and the heating roller 61, the sheet S and the foil film F are heated and pressurized by the heating roller 61 and the pressure roller 51, and the transferring layer F22 is transferred onto the toner image. Note that, in the following description, the transferring of the transferring layer F22 onto the toner image is also referred to simply as “foil transfer”.

After the foil transfer is performed, the sheet S and the foil film F are conveyed to the second guiding shaft 42 in a state that the sheet S and the foil film F are tightly in contact with each other. When the sheet S and the foil film F travel through the second guiding shaft 42, the conveying direction of the foil film F (specifically, the supporting layer F1) changes to a direction different from the conveying direction of the sheet S, and thus the foil film F is peeled from the sheet S.

The foil film F peeled from the sheet S will be wound onto the winding reel 35. Meanwhile, the sheet S from which the foil film F has been peeled will be discharged to the outside of the housing 2 by the sheet discharging mechanism 12.

The film cartridge FC selectively has a first film unit FU1 depicted in FIG. 3A, a second film unit FU2 depicted in FIG. 3B, or a third film unit FU3 depicted in FIG. 3C. Note that, in the following description, a width direction of the foil film F and a width direction of the sheet S are also referred to simply as a “width direction”.

As depicted in FIG. 3A, the first film unit FU1 includes a first foil film F10 of which width is a first width H1, and the first foil film F10 is arranged deviated to one side in the width direction. The first film unit FU1 holds the first foil film F10 so that the first foil film F10 is arranged deviated to one end-side of the heating roller 61 in a state that the first film unit FU1 is attached to the foil transferring apparatus 1. Note that the first width H1 is smaller than the width of the largest sheet S among the sheets S those can be used in the foil transferring apparatus 1, and is 110 mm (half the size of a third width H3 to be described later) as an example.

As depicted in FIG. 3B, the second film unit FU2 includes a second foil film F20 of which width is a second width H2, and the second foil film F20 is arranged at the center in the width direction. The second film unit FU2 holds the second foil film F20 so that the second foil film F20 is positioned at the center in the axial direction of the heating roller 61 when the second film unit FU2 is attached to the foil transferring apparatus 1. Note that the second width H2 is smaller than the width of the largest sheet S among the sheets S those can be used in the foil transferring apparatus 1, and is 110 mm (half the size of the third width H3 to be described later) as an example.

As depicted in FIG. 3C, the third film unit FU3 includes a third foil film F30 of which width is the third width H3. The third film unit FU3 holds the third foil film F30 so that the third foil film F30 is arranged over one end to the other end of the heating roller 61 in a state that the third film unit FU3 is attached to the foil transferring apparatus 1. Note that the third width H3 is the maximum width of the foil film F that can be placed in the film cartridge FC. In other words, the third width H3 is a width greater than the width of the largest sheet S among the sheets S those can be used in the foil transferring apparatus 1, and is 220 mm as an example.

In the memory 100 of the first film unit FU1, “end position” information indicating that the position of the foil film F is a position deviated to one side in the width direction is stored as information indicating the position of the foil film F, and “half width” information indicating that the width of the foil film F is half the size of the third width H3 is stored as information indicating the width of the foil film F. In the memory 100 of the second film unit FU2, “central position” information indicating that the position of the foil film F is the center in the width direction is stored as the information indicating the position of the foil film F, and the “half width” information same as that in the first film unit FU1 is stored as the information indicating the width of the foil film F. In the memory 100 of the third film unit FU3, the “central position” information same as that in the second film unit FU2 is stored as the information indicating the position of the foil film F, and “full width” information indicating that the width of the foil film F is the third width H3 is stored as the information indicating the width of the foil film F.

In the following, the film cartridge FC to which the first film unit FU1 has been attached is also referred to as the first film cartridge FC1. The film cartridge FC to which the second film unit FU2 has been attached is also referred to as the second film cartridge FC2, and the film cartridge FC to which the third film unit FU3 has been attached is also referred to as the third film cartridge FC3.

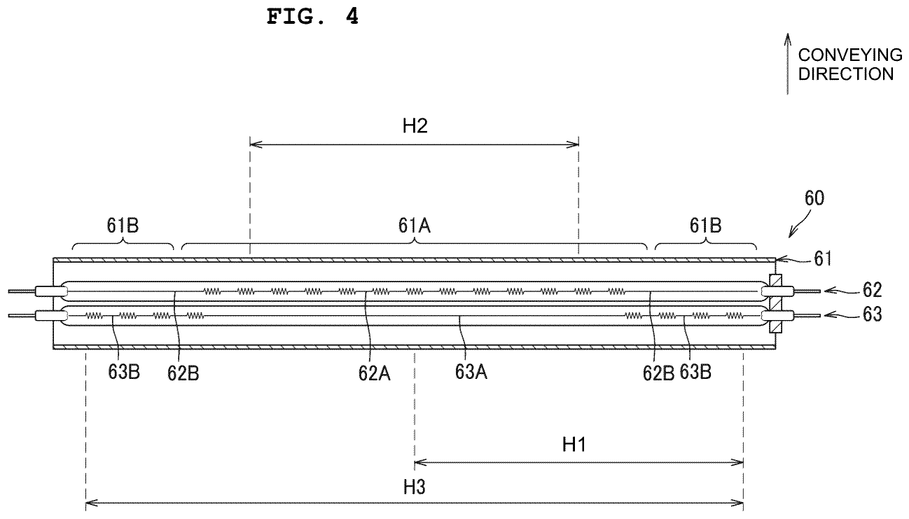

As depicted in FIG. 4, the heating roller 61 has a central region 61A including the central part of the heating roller 61 in the width direction and end regions 61B each located outside the central region 61A in the width direction. The end regions 61B are located on one side and the other side of the central region 61A in the width direction, respectively.

Regarding the first heater 62, output in a central part 62A in the width direction is greater than output in both end parts 62B in the width direction. Therefore, the first heater 62 is configured to heat the central region 61A of the heating roller 61 more strongly than the end regions 61B.

Regarding the second heater 63, output in both end parts 63B in the width direction is greater than output in a central part 63A in the width direction. Therefore, the second heater 63 is configured to heat the end regions 61B of the heating roller 61 more strongly than the central region 61A.

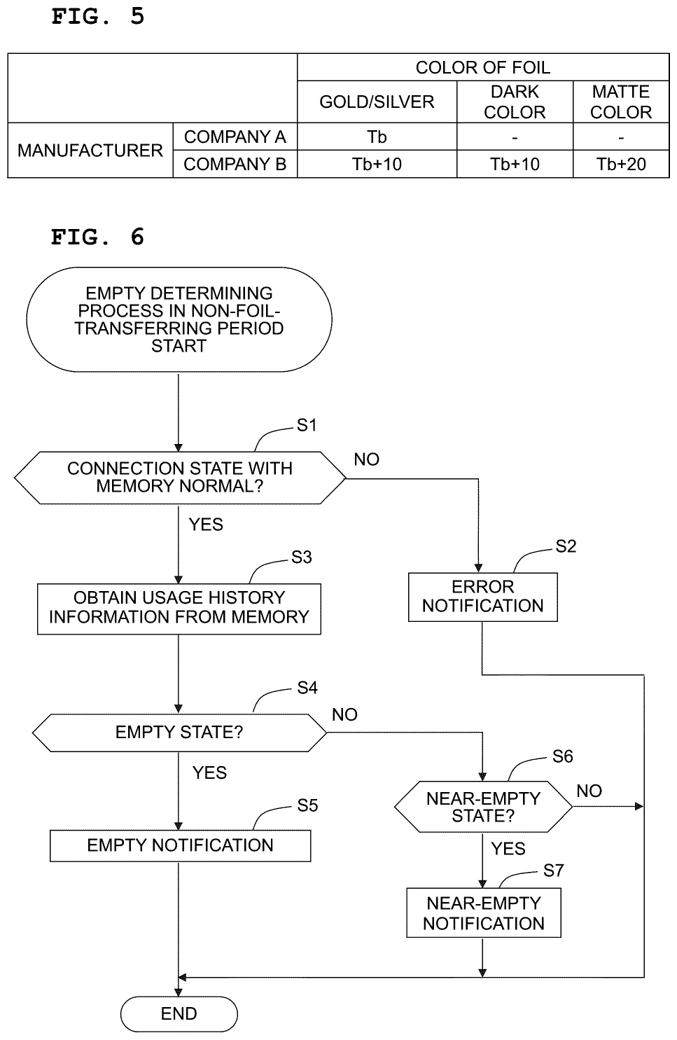

The controller 160 stores a table depicted in FIG. 5. The controller 160 has a function of changing an amount of heat to be applied per unit area of the foil film F from the heating roller 61 by setting a target temperature of the heating roller 61 based on the information indicating the type of the foil film F obtained from the memory 100 and the table.

The table is a table configured to indicate a relationship among the information indicating a color of foil, the manufacturer information indicating a manufacturer of the foil film F, and the target temperature. In a case where the manufacturer information is “Company A”, the controller 160 sets the target temperature to the standard temperature Tb (° C.). Here, since Company A does not manufacture the foil film F having dark colored foil or matte colored foil, the target temperatures for dark color and matte color are not set in the table.

In a case where the manufacturer information is “Company B” and the information indicating the color of the foil is gold or silver, the controller 160 sets the target temperature to “Tb+10 (° C.)”. In a case where the manufacturer information is “Company B” and the information indicating the color of the foil is dark, the controller 160 sets the target temperature to “Tb+10 (° C.)”. In a case where the manufacturer information is “Company B” and the information indicating the color of the foil is matte, the controller 160 sets the target temperature to “Tb+20 (° C.)”.

Note that, although not depicted in the drawing, the transferring part 50 includes a temperature sensor configured to detect the temperature of the heating roller 61. The controller 160 controls an electric current to be applied to at least one of the first heater 62 and the second heater 63 so that the temperature detected by the temperature sensor is the target temperature.

The controller 160 has a function of selecting at least one of the first heater 62 and the second heater 63, to perform the foil transfer, based on the information indicating the width and the position of the foil film F obtained from the memory 100. In this embodiment, the controller 160 applies an electric current to the first heater 62 and does not apply an electric current to the second heater 63 in a case where the information indicating the position of the foil film F and the information indicating the width of the foil film F obtained from the memory 100 is the “central position” and the “half width”. In a case where the information indicating the position of the foil film F obtained from the memory 100 is not the “central position” or the information indicating the width of the foil film F obtained from the memory 100 is not the “half width”, the controller 160 applies an electric current to both the first heater 62 and the second heater 63.

The controller 160 has a function of determining whether a remaining amount of the foil film F is in an empty state based on the usage history information obtained from the memory 100. The empty state is a state in which the remaining amount of the foil film F is a first predetermined amount or less. The controller 160 has a function of determining whether the remaining amount of the foil film F is in a near-empty state based on the usage history information obtained from the memory 100. The near-empty state is a state in which the remaining amount of the foil film F is a second predetermined amount, greater than the first predetermined amount, or less. In a case where the controller 160 determines that the remaining amount of the foil film F is in the near-empty state, the controller 160 reduces the conveying speed of the sheet S compared to a speed when the controller determines that the remaining amount of the foil film F is not in the near-empty state. Specifically, the controller 160 controls the conveying speed of the sheet S in the sheet conveying part 10 and the conveying speed of the sheet S and the foil film F in the transferring part 50 by controlling the rotation speed of the main motor M.

Next, the operation of the controller 160 will be described in detail.

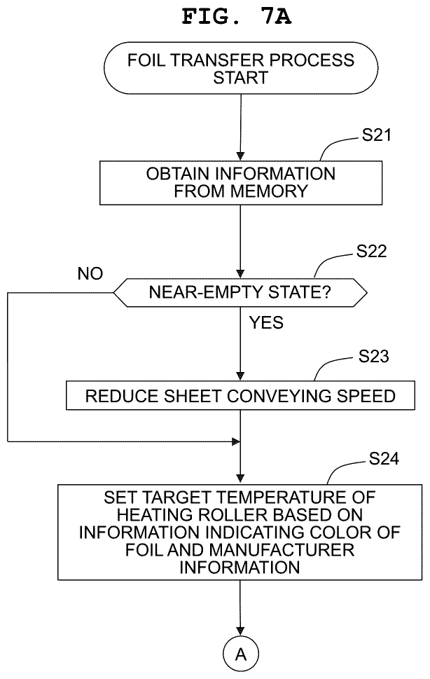

In a case where the power of the foil transferring apparatus 1 is turned on, or in a case where the cover 22 is closed, the controller 160 executes the empty determining process in non-foil-transferring period depicted in FIG. 6. Here, the determining of whether the cover 22 is closed may be performed, for example, based on a signal from a cover sensor configured to detect closing of the cover 22.

In the empty determining process in non-foil-transferring period, the controller 160 first determines whether a connection state between the memory 100 and the reader 150 is normal (S1). Here, the determining of whether the connection state between the memory 100 and the reader 150 is normal may be performed, for example, based on the voltage applied to the reader 150.

In a case where the controller 160 determines in the step S1 that the connection state is not normal (No), the controller 160 notifies an error indicating, for example, that the film cartridge FC is not attached to the housing body 21 (S2), and terminates the process. In a case where the controller 160 determines in the step S1 that the connection state is normal (Yes), the controller 160 obtains the usage history information from the memory 100 (S3).

After the step S3, the controller 160 determines whether the remaining amount of the foil film F is in the empty state, based on the usage history information (S4). In a case where the controller 160 determines in the step S4 that the remaining amount of the foil film F is in the empty state (Yes), the controller 160 notifies that the remaining amount of the foil film F is in the empty state (S5), and terminates the process.

In a case where the controller 160 determines in the step S4 that the remaining amount of the foil film F is not in the empty state (No), the controller 160 determines whether the remaining amount of the foil film F is in the near-empty state, based on the usage history information (S6). In a case where the controller determines in the step S6 that the remaining amount of the foil film F is in the near-empty state (Yes), the controller 160 notifies that the remaining amount of the foil film F is in the near-empty state (S7), and terminates the process. In a case where the controller 160 determines in the step S6 that the remaining amount of the foil film F is not in the near-empty state (No), the controller 160 terminates the process.

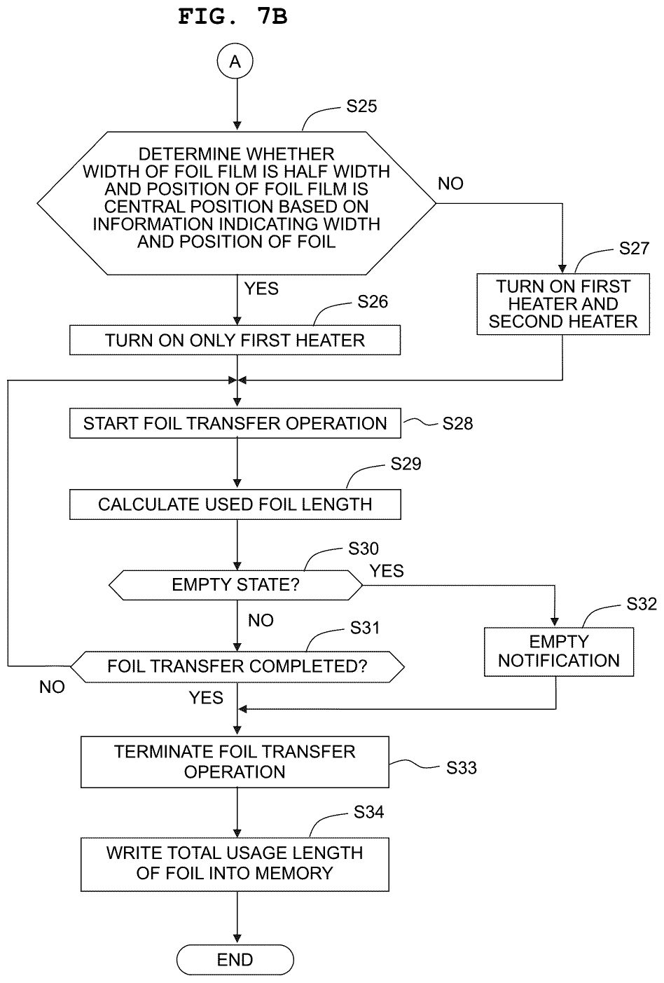

In a case where the controller 160 receives a foil transfer instruction for executing the foil transfer, the controller 160 executes the foil transfer process depicted in FIGS. 7A and 7B. Here, for example, the foil transfer instruction is outputted from an operation panel to the controller 160 in a case where a user presses a start button on the operation panel disposed on an external surface of the foil transferring apparatus 1. In the foil transfer process, the controller 160 first obtains, from the memory 100, the manufacturer information on the foil film F, the information indicating a color of foil, the information indicating a position and a width of the foil film F, and the usage history information (S21).

After the step S21, the controller 160 determines whether the remaining amount of the foil film F is in the near-empty state, based on the usage history information (S22). In a case where the controller 160 determines in the step S22 that the remaining amount of the foil film F is in the near-empty sate (Yes), the controller 160 sets the conveying speed of the sheet S to a second speed, which is lower than a first speed used when the controller determines that the remaining amount of the foil film F is not in the near-empty state (S23).

After the step S23, the controller 160 sets the target temperature of the heating roller 61 based on the information indicating the color of the foil and the manufacturer information obtained from the memory 100 and the table in FIG. 5 (S24). After the step S24, the controller 160 determines whether the width of the foil film F is the “half width” and the position of the foil film F is the “central position”, based on the information indicating the width and the position of the foil film F obtained from the memory 100 (S25).

In a case where the controller 160 determines in the step S25 that the width of the foil film F is the “half width” and the position of the foil film F is the “central position” (Yes), the controller 160 turns on only the first heater 62 (S26). In a case where the controller 160 determines in the step S25 that the width of the foil film F is not the “half width” or the position of the foil film F is not the “central position” (No), the controller 160 turns on both the first heater 62 and the second heater 63 (S27).

After the step S26 or the step S27, the controller 160 starts the foil transfer operation (S28). Specifically, in the step S28, the controller 160 starts conveying of the sheet S by driving the main motor M in a case where the temperature of the heating roller 61 reaches a temperature close to the target temperature. Then, at the timing when the sheet S reaches the transferring part 50, the controller 160 press the heating roller 61 against the pressure roller 51 and rotate the heating roller 61 and the pressure roller 51 so as to convey the sheet S and foil film F by the nip part of the transferring part 50 and transfer the foil onto the sheet S.

After the step S28, the controller 160 calculates a length of the foil film F having been used for one sheet S (S29). Note that, in the following description, the length of the foil film F having been used is also referred to as a “used length”. In addition to the method described above, the used length of the foil film F can also be calculated based on, for example, the peripheral length and the number of rotations of the pressure roller 51 in a time period in which the heating roller 61 is pressed against the pressure roller 51.

After the step S29, the controller 160 calculates a total used length by adding the used length of the foil film F calculated in the step S29 to the usage history information, and determines whether the remaining amount of the foil film F is in the empty state based on the total used length (S30). Note that, in a case where the controller 160 performs the foil transfer on the second or subsequent sheets S, the controller 160 calculates the total used length in the step S30 by adding the used length of the foil film F calculated in the step S29 to the previously calculated total used length.

In a case where the controller 160 determines in the step S30 that the remaining amount of the foil film F is not in the empty state (No), the controller 160 determines whether the foil transfer to the sheet(s) S as much as the number specified by the foil transfer instruction has been completed (S31). In a case where the controller 160 determines in the step S31 that the foil transfer has not been completed (No), the controller 160 returns to the process of the step S28 to start the foil transfer to the next sheet S.

In a case where the controller 160 determines that the foil transfer has been completed in the step S31 (Yes), the controller 160 terminates the foil transfer operation (S33). Specifically, in the step S33, the controller 160 stops the main motor M and turns off both the first heater 62 and the second heater 63.

In a case where the controller 160 determines in the step S30 that the remaining amount of the foil film F is in the empty state (Yes), the controller 160 notifies that the remaining amount of the foil film F is in the empty state (S32), and terminates the foil transfer operation (S33). After the step S33, the controller 160 writes the total used length into the memory 100 (S34), and terminates the process.

Next, specific examples of the operation of the controller 160 will be described.

In the foil transfer process, in a case where the information indicating the color of the foil and the manufacturer information obtained by the controller 160 from the memory 100 is “gold” and “Company A”, respectively, the controller 160 sets the target temperature of the heating roller 61 to Tb (° C.) and executes the foil transfer. In the foil transfer process, in a case where the information indicating the color of the foil and the manufacturer information obtained by the controller 160 from the memory 100 is “gold” and “Company B”, respectively, the controller 160 sets the target temperature of the heating roller 61 to Tb+10 (° C.) and executes the foil transfer. Therefore, the controller 160 can execute the optimal foil transfer according to the material of the foil film F manufactured by each manufacturer.

In the foil transfer process, in a case where the information indicating the color of the foil and the manufacturer information obtained by the controller 160 from the memory 100 is “matte color” and “Company B”, respectively, the controller 160 sets the target temperature of the heating roller 61 to Tb+20 (C) and executes the foil transfer. Therefore, the controller 160 can execute the optimal foil transfer according to the difference in the color of the foil.

In a case where the controller 160 executes the foil transfer process in a state that the second film cartridge FC2 depicted in FIG. 3B is attached to the housing body 21, the controller 160 reads information indicating that the width of the foil film F is the “half width” and the position of the foil film F is the “central position” from the memory 100 of the second film unit FU2. Consequently, the controller 160 turns on only the first heater 62, and thus power consumption can be reduced.

According to the above, the present embodiment achieves the following effects.

The controller 160 changes the amount of heat to be given to a unit area of the foil film F from the heating roller 61 based on the information indicating the type of the foil film F obtained from the memory 100. Therefore, the controller 160 can perform the foil transfer appropriately, by using the information in the memory 100 of the film cartridge FC.

The controller 160 sets the target temperature suitable for each color of the foil. Therefore, the controller 160 can perform the foil transfer appropriately.

Even if a material of the foil film F varies manufacturer by manufacturer, the controller 160 sets the target temperature suitable for each manufacturer. Therefore, the controller 160 can perform the foil transfer appropriately.

In a case where the remaining amount of the foil film F is in the near-empty state, the controller 160 reduces the conveying speed of the sheet S. Therefore, even if the foil film F breaks and separates from the supplying reel 31 in a case of empty, occurrence of catching of the broken end of the foil film F into the transferring part 50 can be reduced.

The controller 160 performs selection regarding the first heater 62 and the second heaters 63 based on the information indicating the width and the position of the foil film F stored in the memory 100. Therefore, the cost can be reduced compared to a configuration, for example, including sensor(s) configured to detect the width and the position of the foil film F.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

A method of changing the amount of heat to be applied per unit area of the foil film from the transferring part may be, for example, a method in which the conveying speeds of the sheet and the foil film are changed. In such method, the lower the conveying speed of the foil film, etc. is, the larger the amount of the heat applied per unit area of the foil film is.

The number of heaters may be one, or may be three or more.

The transferring part may have a configuration, for example, including a belt, a heater, and a pressure roller that nips the belt with the heater at a position between the heater and the pressure roller.

In the above embodiment, a foil transferring apparatus is exemplified by an apparatus in which the foil is transferred onto the toner image formed on the sheet. However, the present invention is not limited thereto. The foil transferring apparatus may be any apparatus configured to transfer foil onto a sheet. For example, a foil transferring apparatus may have a configuration having a thermal head as a heating member for heating a sheet and a foil film. Further, a foil transferring apparatus may be an apparatus configured to transfer a foil onto an ink image formed on a sheet.

In the above embodiment, a film may be used instead of the foil film F. The film may have a configuration same as the configuration of the foil film F except that the transferring layer F22 does not include foil. In a case where the film is used in the foil transferring apparatus 1, the foil transferring apparatus 1 is substantially a transferring apparatus configured to transfer the transferring layer to a sheet.

In the above embodiment, the controller 160 obtains information which has been read by the reader 150 via the contact between the electric contact 151 and the electric contact surface 120, and changes the amount of the heat to be applied per unit area of the foil film F from the heating roller 61 based on the obtained information. However, there is no limitation thereto. For example, the electric contact 151 disposed in the housing body 21 may be omitted, and/or the memory 100 may not include the electric contact surface 120. The controller 160 may obtain information stored in the memory 100 via any wired communication or any wireless communication.

Any combination of each elements described in the aforementioned embodiments and modifications may be adopted.

What is claimed is:

1. A foil transferring apparatus comprising:
a housing having a receiver configured to receive a film cartridge, and an opening, the film cartridge being configured to be attached to and detached from the receiver through the opening, the film cartridge including:
a supplying reel to which a foil film having foil is wound;
a winding reel configured to wind the foil film; and
a memory storing information indicating a type of the foil film;
a transferring part configured to transfer the foil to a sheet by heating the foil film and the sheet in a state that the film cartridge is attached to the receiver and that the foil film supplied from the supplying reel and the sheet are overlapped with each other; and
a controller configured to change an amount of heat to be applied per unit area of the foil film from the transferring part based on the information indicating the type of the foil film obtained from the memory.

2. The foil transferring apparatus according to claim 1, further comprising an electric contact disposed in the housing, wherein:
the memory has an electric contact surface configured to contact the electric contact in a state that the film cartridge is attached to the housing; and
the controller is disposed in the housing, and is configured to obtain the information indicating the type of the foil film from the memory via contact between the electric contact and the electric contact surface.

3. The foil transferring apparatus according to claim 1, wherein the controller is configured to change the amount of the heat to be applied per unit area of the foil film from the transferring part by setting a target temperature of the transferring part.

4. The foil transferring apparatus according to claim 3, wherein:
the memory stores, as the information indicating the type of the foil film, information indicating a color of the foil; and
the controller is configured to set the target temperature based on the information indicating the color of the foil obtained from the memory.

5. The foil transferring apparatus according to claim 3, wherein:
the memory stores, as the information indicating the type of the foil film, manufacturer information indicating a manufacturer of the foil film; and
the controller is configured to set the target temperature based on the manufacturer information obtained from the memory.

6. The foil transferring apparatus according to claim 1, wherein:
the memory is configured to store usage history information on the foil film; and
the controller is configured to determine whether a remaining amount of the foil film is in an empty state based on the usage history information obtained from the memory, the empty state being a state in which the remaining amount of the foil film is a first amount or less.

7. The foil transferring apparatus according to claim 6, wherein the controller is configured to:
determine whether the remaining amount of the foil film is in a near-empty state based on the usage history information obtained from the memory, the near-empty state being a state in which the remaining amount of the foil film is a second amount or less, the second amount being larger than the first amount; and
in a case where the controller determines that the remaining amount of the foil film is in the near-empty state, reduce a conveying speed of the sheet as compared to a conveying speed of the sheet when the controller determines that the remaining amount of the foil film is not in the near-empty state.

8. The foil transferring apparatus according to claim 1, wherein the transferring part includes:
a heater;
a heating roller configured to be heated by the heater; and
a pressure roller configured to nip the sheet and the foil film with the heating roller.

9. The foil transferring apparatus according to claim 8, wherein:
the heating roller includes:
a central region including a central part of the heating roller in a width direction of the sheet; and
an end region positioned outside of the central region in the width direction;
the heater includes:
a first heater configured to heat the central region more strongly than the end region; and
a second heater configured to heat the end region more strongly than the central region;
the memory stores information indicating a width of the foil film and information indicating a position of the foil film; and
the controller is configured to execute the transferring of the foil to the sheet by selecting the first heater and/or the second heater based on the information indicating the width of the foil film and the information indicating the position of the foil film obtained from the memory.

10. A foil transferring method executable by a foil transferring apparatus, the foil transferring apparatus including:
a housing having a receiver configured to receive a film cartridge, and an opening, the film cartridge being configured to be attached to and detached from the receiver through the opening, the film cartridge including:
a supplying reel to which a foil film having foil is wound;
a winding reel configured to wind the foil film; and
a memory storing information indicating a type of the foil film;
a transferring part configured to transfer the foil to a sheet; and
a controller,
the foil transferring method comprising:
heating the foil film and the sheet by the transferring part in a state that the film cartridge is attached to the receiver and that the foil film supplied from the supplying reel and the sheet are overlapped with each other;
obtaining the information indicating the type of the foil film from the memory, by the controller; and
changing, by the controller, an amount of heat to be applied per unit area of the foil film from the transferring part based on the information indicating the type of the foil film obtained from the memory.

11. A transferring apparatus comprising:
a housing having a receiver configured to receive a film cartridge, and an opening, the film cartridge being configured to be attached to and detached from the receiver through the opening, the film cartridge including:
a supplying reel to which a film is wound, the film including a transferring layer and a support layer supporting the transferring layer;
a winding reel configured to wind the film; and
a memory storing information indicating a type of the film;
a transferring part configured to transfer the transferring layer to a sheet by heating the film and the sheet in a state that the film cartridge is attached to the receiver and that the film supplied from the supplying reel and the sheet are overlapped with each other; and
a controller configured to change an amount of heat to be applied per unit area of the film from the transferring part based on the information indicating the type of the film obtained from the memory.

12. The transferring apparatus according to claim 11, further comprising an electric contact disposed in the housing, wherein:
the memory has an electric contact surface configured to contact the electric contact in a state that the film cartridge is attached to the housing; and
the controller is disposed in the housing, and is configured to obtain the information indicating the type of the film from the memory via contact between the electric contact and the electric contact surface.

13. The transferring apparatus according to claim 11, wherein the controller is configured to change the amount of the heat to be applied per unit area of the film from the transferring part by setting a target temperature of the transferring part.

14. The transferring apparatus according to claim 13, wherein:
the memory stores, as the information indicating the type of the film, information indicating a color of the transferring layer; and
the controller is configured to set the target temperature based on the information indicating the color of the transferring layer obtained from the memory.

15. The transferring apparatus according to claim 13, wherein:
the memory stores, as the information indicating the type of the film, manufacturer information indicating a manufacturer of the film; and
the controller is configured to set the target temperature based on the manufacturer information obtained from the memory.

16. The transferring apparatus according to claim 11, wherein:
the memory is configured to store usage history information on the film; and
the controller is configured to determine whether a remaining amount of the film is in an empty state based on the usage history information obtained from the memory, the empty state being a state in which the remaining amount of the film is a first amount or less.

17. The transferring apparatus according to claim 16, wherein the controller is configured to:
determine whether the remaining amount of the film is in a near-empty state based on the usage history information obtained from the memory, the near-empty state being a state in which the remaining amount of the film is a second amount or less, the second amount being larger than the first amount; and
in a case where the controller determines that the remaining amount of the film is in the near-empty state, reduce a conveying speed of the sheet as compared to a conveying speed of the sheet when the controller determines that the remaining amount of the film is not in the near-empty state.

18. The transferring apparatus according to claim 11, wherein the transferring part includes:
a heater;
a heating roller configured to be heated by the heater; and
a pressure roller configured to nip the sheet and the film with the heating roller.

19. The transferring apparatus according to claim 18, wherein;
the heating roller includes:
a central region including a central part of the heating roller in a width direction of the sheet; and
an end region positioned outside of the central region in the width direction;
the heater includes:
a first heater configured to heat the central region more strongly than the end region; and
a second heater configured to heat the end region more strongly than the central region;
the memory stores information indicating a width of the film and information indicating a position of the film; and
the controller is configured to execute the transferring of the transferring layer to the sheet by selecting the first heater and/or the second heater based on the information indicating the width of the film and the information indicating the position of the film obtained from the memory.

20. A transferring method executable by a transferring apparatus, the transferring apparatus including:
a housing having a receiver configured to receive a film cartridge, and an opening the film cartridge being configured to be attached to and detached from the receiver through the opening, the film cartridge including:
a supplying reel to which a film is wound, the film including a transferring layer and a supporting layer supporting the transferring layer;
a winding reel configured to wind the film; and
a memory storing information indicating a type of the film;
a transferring part configured to transfer the transferring layer to a sheet; and
a controller,
the transferring method comprising:
heating the film and the sheet by the transferring part in a state that the film cartridge is attached to the receiver and that the film supplied from the supplying reel and the sheet are overlapped with each other;
obtaining the information indicating the type of the film from the memory, by the controller, and
changing, by the controller, an amount of heat to be applied per unit area of the film from the transferring part based on the information indicating the type of the film obtained from the memory.
